(19) United States
(12) Patent Application Publication
(10) Pub. No.: US 2025/0276618 A1
(43) Pub. Date: Sep. 4, 2025

(54) VEHICLE SEAT WITH FRAME SCREW CONNECTION

(71) Applicant: GRAMMER Aktiengesellschaft, Ursensollen (DE)

(72) Inventor: Florian SCHANDERL, Schwarzenfeld (DE)

(73) Assignee: GRAMMER Aktiengesellschaft, Ursensollen (DE)

(21) Appl. No.: 19/047,449

(22) Filed: Feb. 6, 2025

(30) Foreign Application Priority Data
Mar. 1, 2024 (DE) 10 2024 106 063.8

(51) Int. Cl. B60N 2/16; B60N 2/90

(52) U.S. Cl. CPC B60N 2/162; B60N 2/929

(57) ABSTRACT

The present invention relates to a vehicle seat comprising a seat part and a vehicle seat base with a lower part and an upper part which is adjustable in height relative thereto, wherein the upper part has a frame for supporting the seat part or the lower part has a frame for fastening the vehicle seat to a vehicle body, wherein the frame comprises a first frame part and a second frame part which are connected to one another by at least one connecting means, characterised in that the frame comprises a first frame part and a second frame part which are connected to one another by at least one connecting means, wherein the frame comprises a first frame part and a second frame part, which are connected to each other by at least one connecting means, wherein the at least one connecting means attaches an additional component to the frame.

### CROSS REFERENCE TO RELATED APPLICATION

This application claims the benefit of German Patent Application No. 10 2024 106 063.8, filed Mar. 1, 2024, the entire contents of which are hereby incorporated herein by reference.

### FIELD

The present invention relates to a vehicle seat comprising a seat part and a vehicle seat base having a lower part and a height-adjustable upper part, wherein the upper part comprises a frame for supporting the seat part or the lower part comprises a frame for attaching the vehicle seat to a body, wherein the frame comprises a first frame part and a second frame part which are connected to each other by at least one connecting means, wherein the at least one connecting means attaches an additional component to the frame.

### BACKGROUND

In motor vehicles, especially in commercial vehicles such as tractors or lorries, the vehicle seats are designed for maximum comfort due to their intensive use. In contrast to seats for passenger cars, such vehicle seats have a suspension in the vehicle seat base in addition to the vehicle suspension. A spring movement or general height adjustability is made possible by a scissor frame arranged between two frames. The lower frame is usually attached to the body of the vehicle, while the upper frame has attachments for at least one sliding rail. These sliding rails allow the seat to be adjusted along the direction of travel. Until now, such mountings have been welded to the side of the frame or bolted to the side of the frame. This lateral arrangement results in forces being exerted on the fixings when a load is applied by the seat structure or by an occupant, which must be transferred to the frame and the shear frame in an unfavourable manner via the lateral fixings. In addition, fitting the fixings requires an additional work step.

### SUMMARY

The present invention provides a vehicle seat which eliminates the aforementioned disadvantages of the prior art and improves the vehicle seat in terms of mechanics, manufacture and design.

The vehicle seat comprises a seat part and a vehicle seat base with a lower part and a height-adjustable upper part, wherein the upper part has a frame for supporting the seat part or the lower part has a frame for fastening the vehicle seat to a body, wherein the frame comprises a first frame part and a second frame part, which are connected to one another by at least one connecting means, wherein the at least one connecting means fastens an additional component to the frame.

As is usual with vehicle seats, the seat part can also have a backrest and a headrest in addition to a seat cushion. In addition, the seat part can also include an armrest. A backrest can extend in a height direction Z of the seat and a seat cushion can extend in a plane spanned by a longitudinal direction X of the seat and a width direction Y of the seat. Height direction Z, longitudinal direction X and width direction Y form a Cartesian coordinate system. The seat cushion and backrest are usually arranged to rotate around an axis of rotation parallel to the width direction Y of the seat, so they do not always have to be arranged along X, Y or Z.

According to the invention, the vehicle seat base enables the seat part to be adjusted in height relative to the body of the vehicle. To this end, the vehicle seat base comprises a lower part, which is attached to the vehicle body, and an upper part, which supports the seat part. Preferably, the upper part and the lower part are connected to each other in a height-adjustable manner.

According to a preferred embodiment, the upper and lower parts are connected to each other by a scissor frame. Typically, the scissor frame comprises at least a first and a second scissor arm, wherein both scissor arms are connected to each other so as to be rotatable about a common pivot axis. Preferably, the first scissor arm is connected to the lower part via a fixed bearing and connected to the upper part via a floating bearing and the second scissor arm is connected to the upper part via a fixed bearing and connected to the lower part via a floating bearing. Alternatively, both scissor arms can be connected to the upper part via a fixed bearing each and connected to the lower part via a floating bearing each or, alternatively, connected to the lower part via a fixed bearing each and connected to the upper part via a floating bearing each.

Preferably, the scissor frame comprises a spring element. The spring element can be connected to the first and second scissor arm. Alternatively, the spring element can be connected to one of the scissor arms and the upper or lower part. Alternatively, the spring element can also be connected to the upper and lower part. The spring element can dampen a movement between the upper and lower part. Such a spring element can be an air spring, for example, whereby the spring hardness can be changed via an internal pressure or an external pressure.

According to a further embodiment, the upper and lower parts are connected to each other in a height-adjustable manner via a spring element. Alternatively, the upper and lower parts can be connected to each other in a height-adjustable manner via a spindle, a rack or a telescopic rod.

According to the invention, the upper or lower part has a frame. The frame of the upper part carries the seat part and thus connects the vehicle seat base to the seat part. The frame of the lower part is attached to the body and thus connects the vehicle seat base to the body.

Since it would be very costly to form a frame in one piece, the frame according to the invention comprises a first and a second frame part. However, since the frame must fulfil high requirements in terms of strength and rigidity due to its use as a load-bearing part in a vehicle seat, in particular of a commercial vehicle, it is necessary to connect the first and second frame parts to one another in accordance with the requirements. For this purpose, at least one connecting means is provided according to the invention.

According to a particularly preferred embodiment, the frame comprises at least four frame parts which are arranged in a rectangular shape, the frame being arranged in its main plane of extension perpendicular to a height direction Z of the seat.

According to a preferred embodiment, the four sides of the rectangle are formed by the four frame parts. Advantageously, at least two frame parts are then of equal length.

In a normal state, the height direction Z of the seat is parallel to the weight force F_{g}. To ensure that the frame is not loaded on one side by a load, for example by the seat part it is supporting, the frame is arranged perpendicular to the height direction Z of the seat in its main extension plane, i.e. the plane spanned by the sides of the frame.

According to a particularly preferred embodiment, the frame has two main struts arranged parallel to one another, each having a central web, an upper web and a lower web, the central web being arranged between the upper and lower webs and the main struts being U-shaped or double-T-shaped in a section perpendicular to their main axis of extension, wherein at least two openings in each of the two main struts, which are U-shaped or double-T-shaped in section, lie opposite one another in their end regions and the frame has at least two cross struts, which connect the two main struts to one another in each case at the end regions of their main extension axis, wherein the main struts are designed to guide at least one sliding element, such as a roller, a slider or a carriage.

For weight and cost reasons, it is unfavourable to form the frame parts from solid material. Instead, the use of hollow tubes in frame constructions has proven to be more effective, as they offer similar mechanical properties in terms of bending, tensile, compression and torsional rigidity while using considerably less material. Struts that have a U-shaped or double-T-shaped cross-section perpendicular to their main axis of extension also offer good mechanical properties. Such struts have a central web as well as an upper and a lower web. The centre web is connected to the upper and lower webs by a material bond or is moulded from one part or made in one piece. The upper and lower webs, on the other hand, are not connected to each other. Preferably, the upper and lower webs are arranged parallel to each other and the centre web is perpendicular to them. These struts are also known as U-profiles, double T-profiles or double T-beams, depending on their cross-section.

According to a further embodiment, the above main struts can be designed as square tubes or round tubes, each of which has at least one opening at the end regions of its main extension axis.

According to a preferred embodiment, the two parallel main struts are arranged with their main extension axis parallel to the longitudinal direction X of the seat and the two cross struts are arranged with their main extension axis parallel to the width direction Y of the seat. Preferably, the cross struts are each connected to the main struts in an end region of their respective main extension axis. Alternatively or additionally, at least one cross struts can connect the two main struts in a central area of their main axis of extension.

Preferably, the openings in the main struts serve to accommodate a sliding element of a scissor arm and/or an attachment of a scissor arm. Alternatively or additionally, the openings serve to accommodate an attachment of a spring element.

Preferably, the upper and lower webs are arranged in their main plane of extension perpendicular to the height axis Z of the seat. Preferably, the upper web and/or the lower web have a running surface for at least one sliding element. The at least one sliding element can then move along a main extension axis of the web. Alternatively, it is also conceivable that the centre web has a running surface for at least one sliding element. The at least one sliding element is preferably a roller. A slider or a carriage or a combination of these would also be conceivable. An additional rail can also be attached to the main struts, which is designed to guide at least one sliding element.

Preferably, the main struts form one of the first or second frame parts, with the cross struts forming the other of the two.

According to a preferred embodiment, the frame has a connecting means in each of the four end regions of the main struts. Further preferably, the frame has at least one further connecting means between the end regions of each main struts. Thus, the frame preferably has a total of at least six, further preferably at least eight connecting means. The connecting means are also preferably arranged in two rows of four, each parallel to the longitudinal direction X.

According to a particularly preferred embodiment, the connecting means comprises at least one screw connection, wherein the frame has at least one passage opening which passes through two of the frame parts, wherein the passage runs parallel to the height direction Z of the seat and the at least one screw connection is arranged within the passage which connects the two frame parts to one another in a non-positive manner.

Preferably, at least one connecting means connects a first frame part, a second frame part and an additional component in a non-positive manner. However, it would also be conceivable for the connection to be positive or a material bond or a combination of the three connections. Two of the three parts mentioned above can also be connected with one type of connection and the last of the components attached to it with another type of connection. For example, the two frame parts are connected with a non-positive connection and the additional component is connected to the connecting means with a material connection.

Preferably, two frame parts or a main struts and a cross struts have a passage in which a screw connection is arranged. For this purpose, at least one of the two frame parts or main struts or cross struts can have an internal thread into which a screw is screwed. Alternatively or additionally, the additional component can have an internal thread into which a screw is screwed. Preferably, the passage runs parallel to the height direction Z of the seat. Preferably, the passage runs through a main strut and a cross strut. It is also preferable that the passage runs through the additional component. According to one embodiment, the passage has the same shape and the same diameter everywhere. Preferably, the shape is a cylinder whose main extension extends along the height direction Z of the seat. It would also be conceivable for the shape to have two different diameters and/or two different shapes.

Preferably, the first and second frame parts are U-shaped in a cross-section perpendicular to their main axis of extension, wherein the second frame part has a lower height in the height direction Z than the first frame part. Further preferably, the second frame part with the lower height than the first frame part is inserted in an end region into an end region of the first frame part, wherein the first frame part at least partially encloses the second frame part. Preferably, the passage is arranged in the end region in which the first frame part at least partially encloses the second frame part, wherein the passage is completely radially enclosed by the frame parts in the height direction Z. Preferably, the main struts are inserted into the cross struts.

According to a particularly preferred embodiment, at least one bushing is inserted into the passage parallel to the height direction Z of the seat, wherein the bushing has a collar at a first end which is larger than the diameter of the passage and the bushing has a second internal thread into which a first screw engages from the second end opposite the collar, wherein the first screw and the bushing connect at least two frame parts to one another in a non-positive manner.

Preferably, the bushing has the shape of the passage and a smaller diameter than the passage. However, it is also conceivable that the bushing has a different shape than the passage. Preferably, the bushing is hollow cylindrical and has an inner surface with an internal thread parallel to its main axis of extension and a collar perpendicular to its main axis of extension, whereby the collar has a larger diameter than the passage in one of the frame parts. This collar can prevent the bushing from slipping through the passage and, in combination with a screw, the two frame parts can be connected in a non-positive manner. Preferably, the outer surface of the bushing does not have a thread. As it serves to hold at least one screw, the bushing can also be referred to as a nut. According to one embodiment, the internal thread extends over the entire length of the bushing. Alternatively, the internal thread can be arranged in sections on the inner surface of the bushing, whereby the bushing has at least two sections with an internal thread and one section without an internal thread.

Preferably, the first screw has a screw shank with an external thread and a screw head. The diameter of the screw head is also preferably diameter of the screw head is larger than the passage opposite the collar of the bushing. Additionally or alternatively, a washer can be arranged between the first screw and the passage, which has a larger diameter than the passage, whereby this lies opposite the collar of the bushing. Additionally or alternatively, a washer with a diameter larger than the passage, which lies opposite the head of the first screw, can also be arranged between the bushing and the passage.

Preferably, the first and second frame parts or the main and cross struts are connected to each other in a non-positive and positive fit, with the positive fit being formed by the collar of the bushing and the head of the screw. The screw and the bushing are connected to each other in a non-positive manner.

Alternatively, the first screw can also be designed without a head and the positive fit and/or the non-positive fit can be formed by a nut that is screwed onto the screw from the side that is not screwed into the bushing.

According to one embodiment, the bushing has an external thread. In this case, the bushing is longer than the passage through the first and second frame parts. The external thread is then arranged at the end of the bushing that is opposite the collar. A nut with a diameter greater than the diameter of the passage is screwed onto the end which has the external thread and which, when the bushing is arranged in the passage, protrudes beyond one end of the passage. The nut and the bushing, which in this case can be described as a threaded insert, create a non-positive connection between the two frame parts.

According to a particularly preferred embodiment the at least one passage is a long hole.

A long hole allows the bushing to be arranged with a certain amount of play due to the expansion of the long hole, which can compensate for component tolerances of the main struts and cross struts.

According to a particularly preferred embodiment the additional component is screwed to the bushing by means of a second screw from the first end, which has the collar.

Preferably, the collar of the bushing, viewed in the height direction Z, is arranged above the frame in the case of an upper part of the vehicle seat base and below the frame in the case of a lower part.

According to a preferred embodiment, the first screw penetrates into the bushing for at least one third and at most two thirds of the total length of the bushing. Preferably, the second screw is screwed into the bushing from the side that is not occupied by the first screw. The second screw can be screwed into the bushing for at least a quarter and at most a third of the total length of the bushing. Preferably, the second screw has a screw shank and a screw head. Particularly preferably, the additional component has a passage that is larger than the diameter of the second screw. Preferably, the second screw is passed through the passage of the additional component and screwed into the bushing. The screw head forms a positive fit between the additional component and the second screw. Alternatively or additionally, a washer and/or a nut can form the positive fit between the second screw and the additional component. The additional component can also have a thread, whereby the additional component and the second screw are connected to each other in a non-positive manner.

Preferably, the additional component rests partially, particularly preferably completely, on the collar of the bushing. It is also possible that the collar of the bushing rests partially, preferably completely, on the component. Of course, it is also conceivable that the additional component is connected to several bushings via several screw connections. In such a case, the additional component preferably rests partially on all collars of the bushings, particularly preferably completely on all collars of the bushings.

According to a preferred embodiment, the at least one connecting means comprises a first screw, a second screw and a nut. Preferably, both the first screw and the second screw are non-positively connected to the nut. Furthermore, the first screw and the nut preferably connect the first and second frame parts in a non-positive manner and the second screw and the nut connect at least one of the two frame parts and the additional component in a non-positive manner.

According to a particularly preferred embodiment, at least one spacer distances the upper and lower webs. The spacer restricts the at least one passage at least partially on the circumference.

The spacer prevents the average distance between the upper and lower webs from being reduced by the application of force to at least one of the webs by a screw connection arranged between the webs. Preferably, the spacer is shaped as a hollow cylindrical sleeve, the height of which corresponds to the distance between the upper and lower struts. This sleeve is arranged within the main struts or the frame part in such a way that it at least partially encloses the passage, with the bushing being inserted into the sleeve or spacer.

According to a particularly preferred embodiment, the at least one spacer forms part of the cross struts.

The fact that the at least one spacer forms part of the cross struts ensures that the spacer remains firmly in place and cannot slip. In addition, no special consideration needs to be given to the alignment of the spacer during installation. For this purpose, a part of the cross struts can be moulded or shaped into a semi-circle, preferably a circle. This semi-circular or circular part then corresponds to the aforementioned sleeve. The spacer is particularly preferably rectangular in shape with an open side.

According to a particularly preferred embodiment, the additional component is at least one attachment for a seat shell arranged above the frame.

According to a particularly preferred embodiment, the additional component is at least one seat rail or slide arranged above or below the frame.

According to a preferred embodiment, the additional component is a pivot axis, wherein the seat part is arranged to be rotatable about the pivot axis. Further preferably, the additional component is the body of a vehicle or a mounting plate arranged on the body. Preferably, the additional component is a stand or a beam of a rocker, wherein the seat part is rotatable relative to the vehicle seat base about a tilt axis parallel to the width direction Y of the vehicle seat.

Preferably, the additional component supports the seat part.

According to a particularly preferred embodiment, the connecting means simultaneously secures the additional component and connects the frame parts in a non-positive manner.

Further objectives, advantages and usefulness of the present invention can be found in the following description in conjunction with the drawings.

### BRIEF DESCRIPTION OF THE DRAWINGS

FIG. 1 an isometric view of a vehicle seat base from the prior art;

FIG. 2 a general view of a vehicle seat according to the invention;

FIG. 3 an isometric view of the vehicle seat base according to the invention;

FIG. 4 an isometric view of the frame

FIG. 5a a part of a section through the frame along a Y-Z plane; FIG. 5b a part of a section through the frame along a Y-Z plane with additional component;

FIG. 6 an isometric view of a cross struts;

FIG. 7 section through the vehicle seat base according to the invention along an X-Z plane.

### DETAILED DESCRIPTION

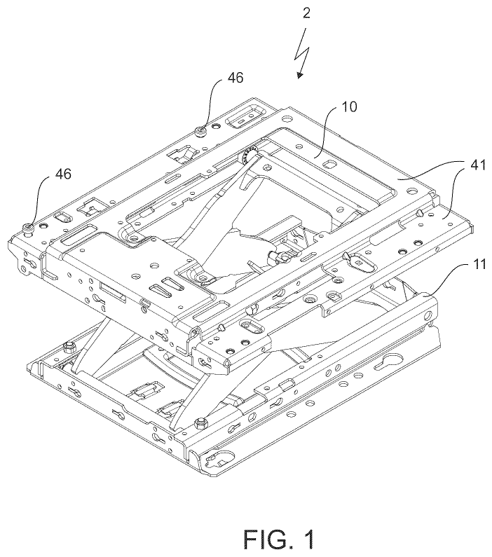

FIG. 1 shows a vehicle seat base 2 of the prior art. The vehicle seat base 2 has an upper part 10 with an upper frame 16 and a lower part 11 with a lower frame 17. A load- bearing component 47 is welded onto the upper frame 16. Fixing screws 46 for a sliding rail 8 are arranged next to the upper frame 16 in the load-bearing component 47.

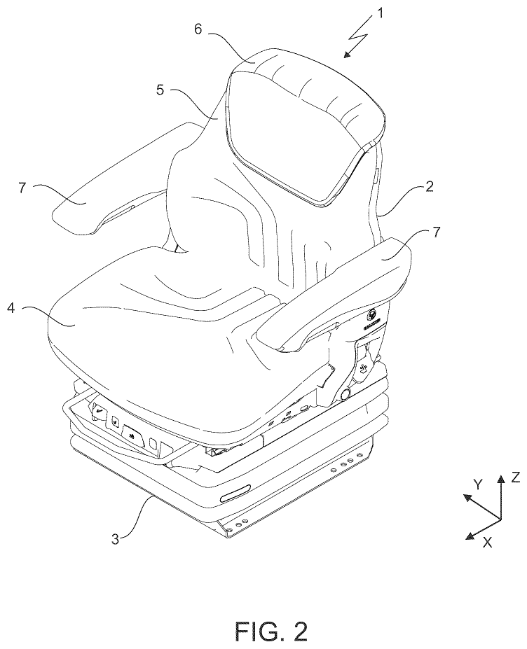

FIG. 2 shows a vehicle seat 1 according to the invention. X is the longitudinal direction of the seat, Y its width direction and Z its height direction. The vehicle seat comprises a seat part 2 and a vehicle seat base 3 arranged below it in the height direction Z, which supports the seat part 2. In addition to a seat cushion 4 extending parallel to an X-Y plane, the seat part 2 comprises a back part 5 extending in the height direction Z with an adjoining headrest 6 and two armrests 7 attached to the side of the backrest and extending parallel to the seat cushion. Several controls are provided for adjusting the seat, including a seat height adjustment, a seat length adjustment, a seat cushion depth and inclination adjustment, a backrest inclination adjustment, a backrest extension, a lumbar support adjustment and a height and inclination adjustment of the armrests. These adjustments can be used to change the orientation and/or position of almost all of the above-mentioned parts in space. Sliding rails 8 are mounted on the vehicle seat base 3 to adjust the seat part 2 in the longitudinal direction X.

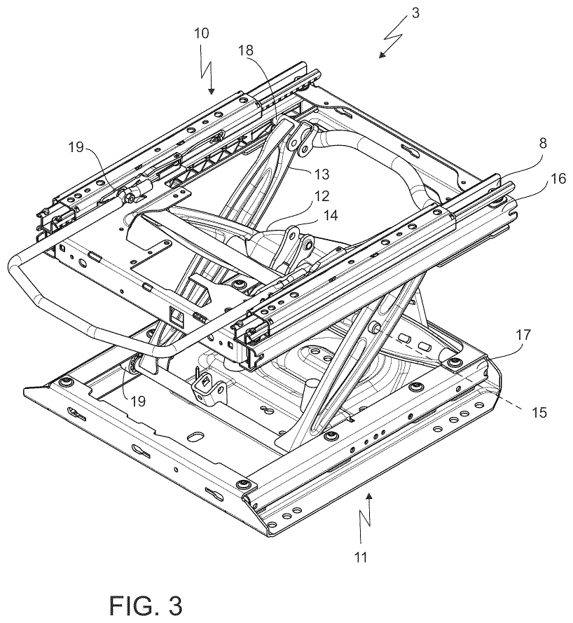

FIG. 3 shows the vehicle seat base 3. The vehicle seat base 3 is divided into an upper part 10 and a lower part 11. A scissor frame 12 is arranged between the upper and lower parts 10, 11. The scissor frame consists of two scissor arms 13, 14. The first scissor arm 13 and the second scissor arm 14 are rectangular in cross-section, with the second scissor arm 14 having a smaller width than the first scissor arm 13. The first scissor arm 13 and the second scissor arm 14 are arranged crosswise, with the second scissor arm 14 being arranged inside the first scissor arm. Parallel to the width direction Y, the scissor arms 13, 14 are rotatably connected to each other along their width about a pivot axis 15. The upper part 10 also has an upper frame 16 for connecting the upper part 10 to the scissor frame 12, and the lower part 11 has a lower frame 17 for connecting the lower part 11 to the scissor frame 12. The first scissor arm 13 is connected to the upper frame 16 via a fixed bearing 18 and to the lower frame 17 via a floating bearing 19. The second scissor arm 14 is connected to the upper frame 16 via a floating bearing 19 and to the lower frame 17 via a fixed bearing. In order to be able to adjust the distance between the upper and lower frames 16, 17, an air spring (not shown here) is arranged between the first scissor arm and the lower frame 17.

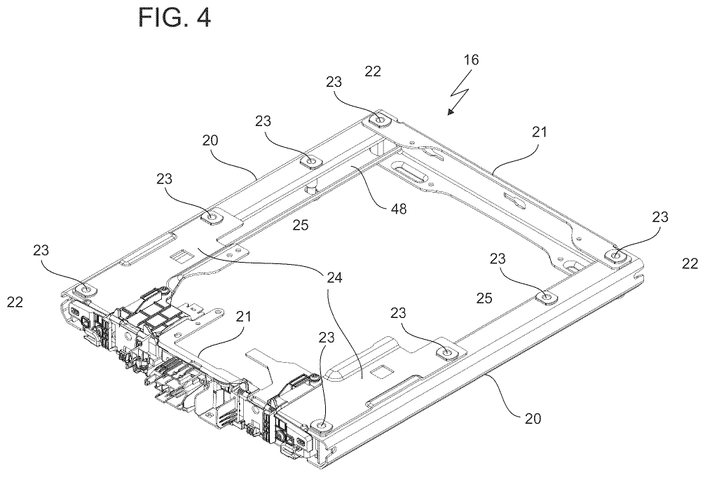

FIG. 4 shows the upper frame 16. The upper frame 16 has two main struts 20 running parallel to each other in the longitudinal direction X. Two cross struts 21 extending in the width direction Y are arranged perpendicularly thereto. The main struts 20 are connected to the cross struts 21 at both end regions 22 of their main extension axis. The connection is made by a total of four connecting means 23. The main struts 20 and cross struts 21 are arranged in a rectangular shape. In order to stabilise the rectangular shape, the front of the cross struts 21 has a bulge 24 which extends along the main axis of the main struts 20. The bulge 24 is each connected to one of the main struts 20 in a central area 25 by a connecting means 23. In addition, each main strut 20 has a further connecting means 23 in its central area, without these connecting means 23 connecting the main strut 20 to a cross strut 21.

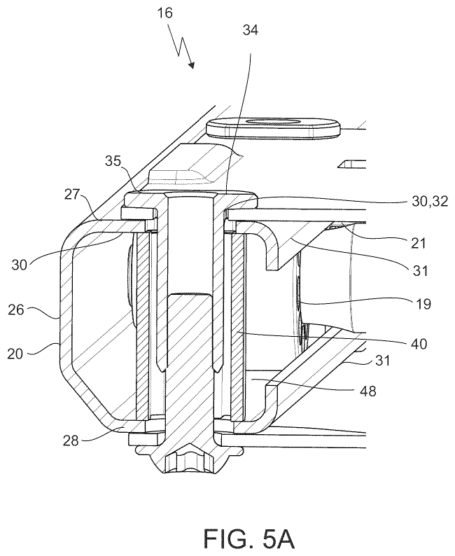

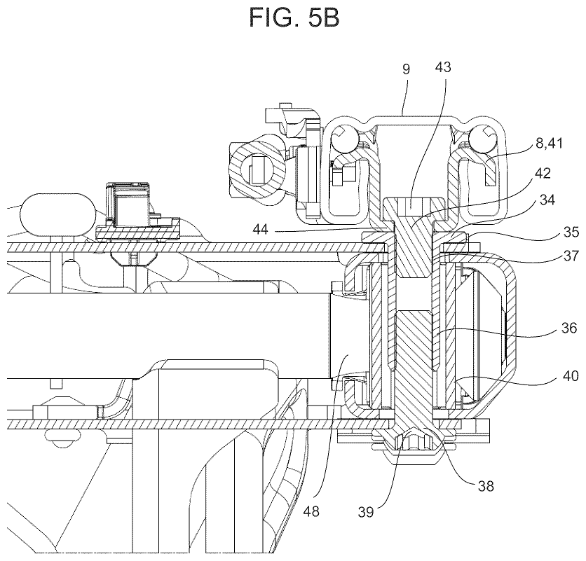

FIGS. 5a and 5b show a sectional view of a connecting element of the upper frame 16 along a Y-Z sectional plane. In this sectional view, the main struts 20 shows a U-shape with a central web 26 forming an outer side of the upper frame 16, an upper web 27 forming an upper side of the upper frame 16 and a lower web 28 forming a lower side of the upper frame 16. A sliding element 29 in the form of a roller 29 is arranged within the space of the main struts 20 enclosed by the webs 26, 27, 28 and a restriction 31. The underside of the upper web 27 forms a running surface 30 for the roller 29, on which it can run in the longitudinal direction X, whereby the roller 29 is prevented from jumping out of the running surface 30 by the restriction 31. The roller 29 and the main struts 20 form a floating bearing 19 of a scissor arm 13, 14. The cross struts 21 partially enclose the main struts 20, i.e. it is arranged partially above and partially below the main struts 20. A passage 32 in the form of a long hole 33, which was punched out of the struts 20, 21, runs through both struts 20, 21. A bushing 34 in the form of a threaded bushing 34 was inserted into the long hole 33 from above. The threaded bushing 34 has a collar 35 shaped as a flange, which prevents the threaded bushing 34 from slipping through the long hole 33. The threaded bushing 34 is also only about two thirds the length of the long hole 33 and can therefore be inserted into the long hole 33, but not through it. In addition, the threaded bushing 34 has a continuous internal thread that can be divided into a first internal thread 36 and a second internal thread 37, the first internal thread 36 covering a lower end of the threaded bushing 34 and the second internal thread 37 covering an upper end of the threaded bushing 34. A first screw 38 is screwed into the first internal thread 36 from the underside of the upper frame 16. The first screw 38 also has a first screw head 39 that has a larger diameter than the long hole 33, which prevents the first screw 38 from slipping through the long hole 33.

When the first screw 38 is tightened against the threaded bushing 34, the collar 35 presses from above and the first screw head 39 presses from below against the cross strut 21, compressing it along the height direction Z. If the cross strut 21 is compressed further, it contacts the main strut 20 and compresses it as well. In order to be able to connect the main struts 20 and cross struts 21 sufficiently non-positive without excessive deformation, part of the cross struts is shaped as a spacer 40. The spacer 40 encloses the shape of the long hole 33 and forms a stop against the contracting first screw 38 and the threaded bushing 34. An additional component 41 in the form of a sliding rail 8 rests on the collar 35. The sliding rail 8 therefore does not contact the frame, but only the collars 35 of the threaded bushes 34, with which the sliding rail 8 is fastened to the upper frame 16. To fasten the sliding rail 8 to the threaded bushing 34, a second screw 42 with a second screw head 43 is inserted into the threaded bushing 34 from above through a punched-out second lead-through 44 of the sliding rail and screwed to the second internal thread 37. In this way, the sliding rail 8 is non-positively connected to the threaded bushing 34 and thus to the main struts 20 and the cross struts 21. The threaded bushing 34 is arranged so that its collar 35 is located directly above the running surface 30 of the roller 29. As a result, a load on the threaded bushing 34 is transmitted directly via the upper web 27 to the roller 29 and thus to the scissor frame 12.

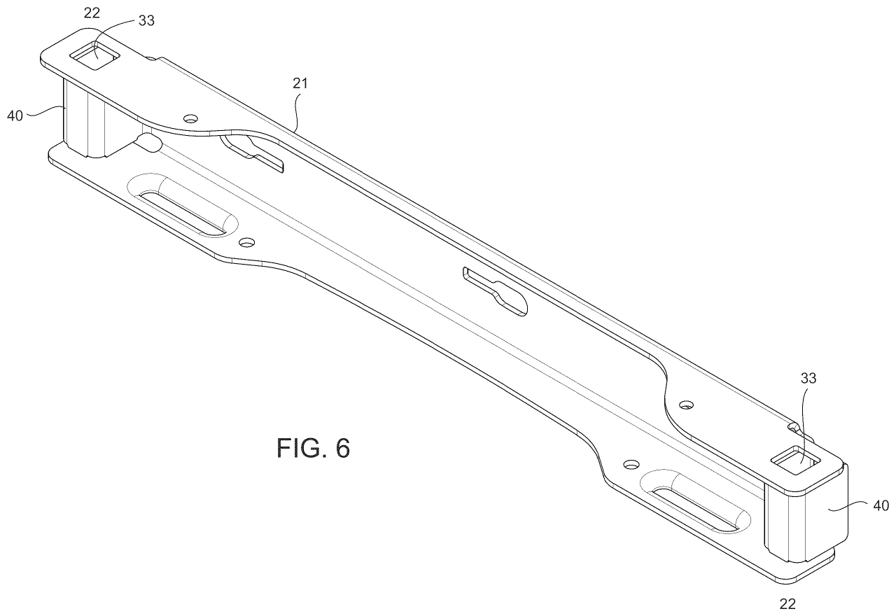

FIG. 6 shows an isometric view of the cross struts 21. The long holes 33 and a spacer 40 surrounding the long hole are shown at each of the two end regions 22. The cross struts 21 form a U-shaped profile similar to the main struts 20. The long holes 33 have a rectangular base, which is enclosed in a U-shape by the spacers 40. The threaded bushes 34, which are not shown here, have a cuboid area below their collar 35, the size of the cuboid corresponding to the diameter of the long hole 33, so that the cuboid area does not completely fill the long hole 33, but prevents the threaded bushing 34 from twisting relative to the long hole when the threaded bushing is inserted into the long hole 33. The spacers 40 are also smaller than the main struts 20, as the spacers 40 are inserted into the main struts 20. The height of the cross struts 21, on the other hand, is greater than that of the main struts 20, as the cross struts 21 enclose the main struts 20.

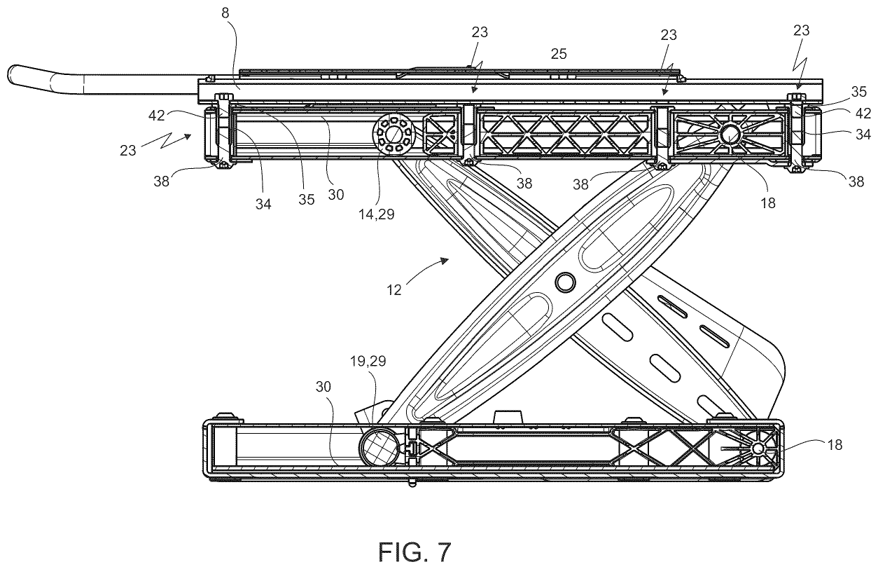

FIG. 7 shows a section through the vehicle seat base 3 along an X-Z plane. Four connecting means 23 are visibly arranged in the upper frame 16. The connecting means 23 connect two frame parts in each of the end regions 22 with a first screw 38 and a bushing 34. A sliding rail 8 rests on the collars 35 of the bushings 34 and is screwed to the bushings 34 by a second screw 42 in each case. Two further connecting means are arranged in the central area 25. The two connecting means 23 in the central area 25 do not have any second screws 42. The sliding rail 8 only rests on the collar 35 of one of the two bushings 34 in the central area 25. The other connecting means 23, on the other hand, has no contact with the sliding rail 8. The connecting means 23 in the central area 25 thus only connect the main struts 20 and cross struts 21 without fastening the sliding rail 8. If necessary, for example in the case of high loads, the connecting means 23 in the central area 25 can also be used to fasten the sliding rail 8. A scissor frame 12 is arranged between the upper part 10 and the lower part 11. Two fixed bearings 18 and floating bearings 19 comprising two rollers 29 can be seen here. The rollers 29 run on the running surfaces 30 of the upper frame 16 and the lower frame 17. The connecting means 23 of the central area 25 are arranged in the path of the running surface 30 of the upper frame 16. In order to prevent the roller 29 and the connecting element 23 from colliding, a stopper 45 is arranged between the two in the interior of the main struts 20 formed by the webs 26, 27, 28. The stopper 45 consists of individual rods that are connected to each other in a truss-like manner. When stopper 45 and roller 29 meet, stopper 45 deforms and thus dampens the movement of roller 29 until maximum deformation of stopper 45 is reached. The stopper 45 then forms a stop for the roller 29.

### LIST OF REFERENCE SIGNS

1 Vehicle seat
2 Seat section
3 Vehicle seat base
4 Seat cushion
5 Back section
6 Headrest
7 Armrest
8 Adjustment rail
9 Adjusting slide
10 Upper section
11 Lower section
12 Scissor frame
13 First scissor arm
14 Second scissor arm
15 Axis of rotation
16 Upper frame
17 Lower frame
18 Fixed bearing
19 Floating bearing
20 Main struts
21 Cross braces
22 End sections
23 Fasteners
24 Bulge
25 Centre area
26 Centre bar
27 Upper bridge
28 Lower bar
29 Displacement element
30 Running surface
31 Limitation
32 Passage
33 Slotted hole
34 Bushing
35 Collar
36 First internal thread
37 Second internal thread
38 First screw
39 First screw head
40 Spacer
41 Additional component
42 Second screw
43 Second screw head
44 Second passage
45 Stopper
46 Fastening screws
47 Supporting component
48 Opening

What is claimed is:

1. A vehicle seat, comprising: a seat part and a vehicle seat base with a lower part and an upper part which is adjustable in height relative thereto, wherein the upper part has a frame for supporting the seat part or the lower part has a frame for fastening the vehicle seat to a vehicle body, wherein the frame comprises a first frame part and a second frame part which are connected to one another by at least one connecting means, wherein
the frame comprises a first frame part and a second frame part which are connected to one another by at least one connecting means, wherein the frame comprises a first frame part and a second frame part, which are connected to each other by at least one connecting means, wherein
the at least one connecting means attaches an additional component to the frame.

2. The vehicle seat according to claim 1, wherein
the frame consists of at least four frame parts which are arranged rectangularly, the frame being arranged in its main plane of extension perpendicular to a height direction of the seat.

3. The vehicle seat according to claim 2, wherein
the frame has two main struts arranged parallel to one another, each with a central web, an upper web and a lower web, wherein the central web is arranged between the upper web and the lower web and the main struts are U-shaped or double-T-shaped in a section perpendicular to their main axis of extension, wherein at least two openings in each of the two main struts, which are U-shaped or double-T-shaped in section, lie opposite one another in their end regions and the frame has at least two cross struts which connect the two main struts to one another in each case at the end regions of their main axis of extension, wherein the main struts are designed to guide at least one sliding element, such as a roller, a slider or a carriage.

4. The vehicle seat according to claim 3, wherein
the connecting means comprises at least one screw connection, wherein the frame has at least one passage which passes through two of the frame parts, wherein the passage extends parallel to the height direction of the seat and the at least one screw connection is arranged within the passage, which connects the two frame parts to one another in a non-positive manner.

5. The vehicle seat according to claim 4, wherein
at least one bushing is inserted into the passage parallel to the height direction of the seat, the bushing having at a first end a collar which is larger than the diameter of the passage and the bushing having a first internal thread in which a first screw engages from the second end opposite the collar, the first screw and the bushing connecting at least two frame parts to one another in a non-positive manner.

6. The vehicle seat according to claim 4, wherein
the at least one passage is a long hole.

7. The vehicle seat according to claim 5, wherein
the additional component is screwed to the bushing by means of a second screw from the first end having the collar.

8. The vehicle seat according to claim 4, wherein
at least one spacer spaces the upper and the lower web and the spacer at least partially circumferentially confines the at least one passage.

9. The vehicle seat according to claim 8, wherein
the at least one spacer forms part of the cross struts.

10. The vehicle seat according to claim 1, wherein
the additional component is at least one attachment for a seat shell arranged above the frame.

11. The vehicle seat according to claim 1, wherein
the additional component is at least one seat rail or a slide arranged above or below the frame.

12. The vehicle seat according to claim 1, wherein
the connecting means simultaneously fastens the additional component and connects the frame parts in a non-positive manner.
